(19) United States
(12) Patent Application Publication
(10) Pub. No.: US 2016/0114333 A1
(43) Pub. Date: Apr. 28, 2016

(54) Pre-Recycling System

(71) Applicants: Geoffrey Sharper, Tallahasse, FL (US); Allen Sharper, Daytona Beach, FL (US)

(72) Inventors: Geoffrey Sharper, Tallahasse, FL (US); Allen Sharper, Daytona Beach, FL (US)

(21) Appl. No.: 13/755,821

(22) Filed: Jan. 31, 2013

(51) Int. Cl. B02C 19/18; B65F 1/00

(52) U.S. Cl. CPC B02C 19/186; B65F 1/0006

(57) ABSTRACT

A pre-recycling system is providing including a collection apparatus containing a plurality of collection bowls adapted to collect material and pass the material to a weigh station. A pressure chamber adapted to flash freeze the material and break down the material with sound waves. A grinding and vacuum chamber adapted to grind the material passing out of the pressure chamber. One or more collection bags adapted to collect waste dust exiting from the grinding and vacuum chamber. The instant abstract is neither intended to define the invention disclosed in this specification nor intended to limit the scope of the invention in any way.

### BRIEF DESCRIPTION OF THE DRAWINGS

FIG. 1 shows a perspective view of a pre-recycling system according to an exemplary embodiment of the present invention;

FIG. 2 shows a cross-sectional view taken along line 2-2 of FIG. 1;

FIG. 3 shows a cross-sectional view taken along line 3-3 of FIG. 1;

FIG. 4 shows a perspective view of a spray and chisel attachment according to an exemplary embodiment of the present invention; and

FIG. 5 shows a perspective view of a vapor to solid attachment according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an exemplary embodiment of the present invention provides a pre-recycling system that handles several categories of waste in waste management. The system may apply pressure, low temperatures and produce dust particles to reduce wasteful energy and space. The system may control waste produced by the world's increasing population growth. The system may benefit both super industrial and up-start developing countries. The system may pre-sort glass, metals, foods, paper, plastics and non-recyclable material to be freeze-flashed and pressurized to introduce a method of pre-recycling. Instead of a consumer taking waste and directly placing it in a waste can that may be recycled, consumers can pre-recycle by color-code to increase waste management productivity and create a possible opportunity to create new goods and services that might stimulate the economy. Further, consumers can take waste and use the present invention to regulate waste storage at home, better serve the environment, and increase global trade of goods and services.

The device includes the following elements:
Data input station to receive data, storage containers to hold waste for processing, sensors to scan and prevent injury, and reduce criminal acts, the use of liquid nitrogen, dewers to store extra liquid nitrogen, pressure chamber, the use of sound waves to agitate frozen mass to reduce its shape and height, and a grinding and vacuumed section to produce and collect dust particles.
A gas mode to filter most types of gases, and pollution of the air. Industrial batteries, mechanical generator, solar, electrical energy to create a nearly self- sustaining system. A final bag system to collect all precycled materials.

Elements used in the present invention include the use and production of liquid nitrogen on a massive scale. Optional elements are accessory attachment parts to break down large equipment and furniture.

The use of materials that will be able to endure pressure, extremely low temperatures, vibrations, sound-waves, would provide optimal system performance.

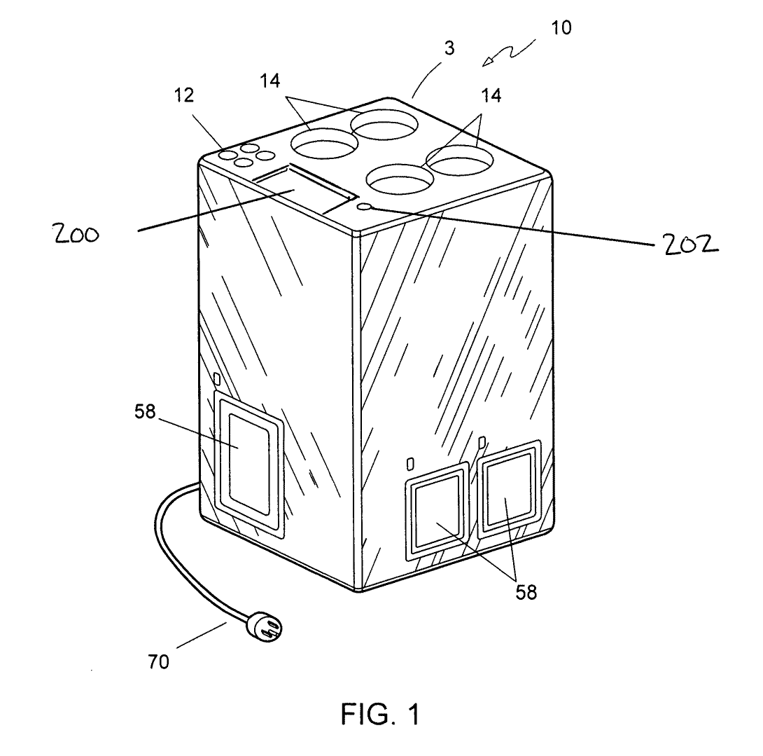

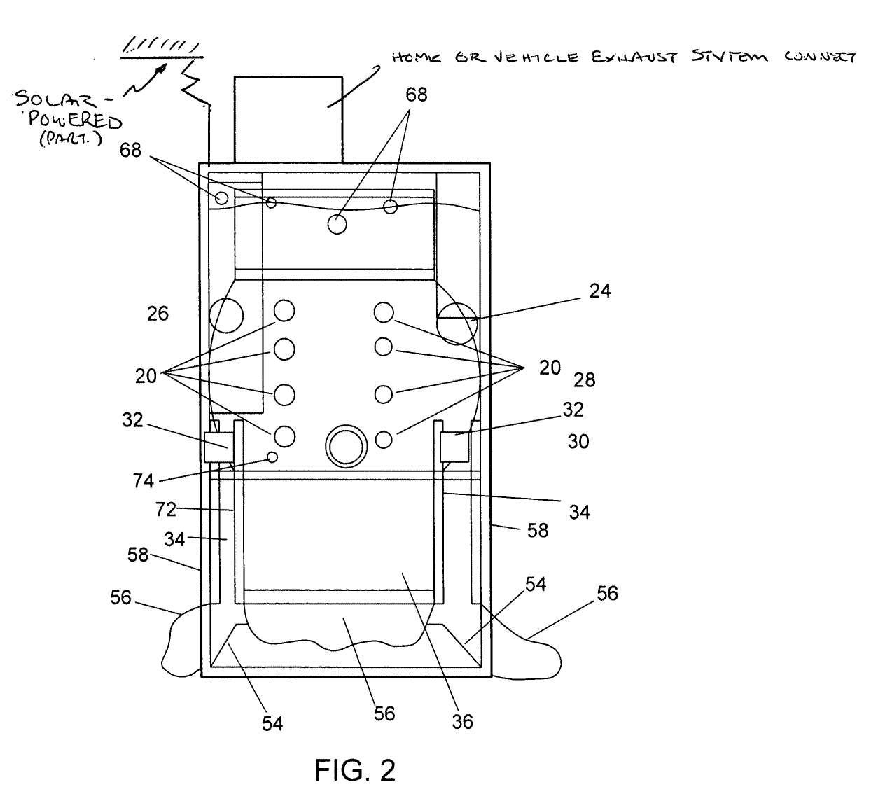

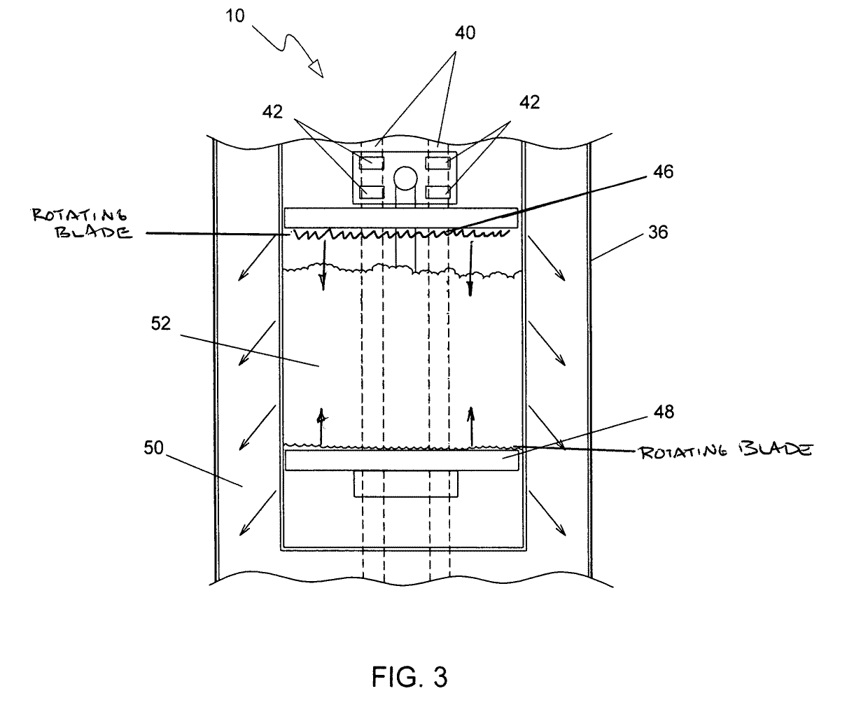

Referring now to FIGS. 1 through 3, a pre-recycling system 10 may include an enclosure 12 having an opening in an upper end thereof, the opening revealing a plurality of collection bowls 14. For example, there may be four color-coded collection bowls 14 for various types of material, such as plastic, metal, glass, food waste, or the like. One or more collection bag access doors 58 may be provided at a lower end of the enclosure 12 to provide access to one or more collection bags 56 disposed within the enclosure 12. A power cord 70 may provide electrical power to the system 10. In some embodiments, solar energy may power all or a portion of the system 10. In some embodiments, batteries 34 may be provided to store energy for use by the system 10.

Waste for pre-recycling may enter the system 10 via the collection bowls 14 and may pass through collection cylinders 16 attached to each of the collection bowls 14. A weigh station 18 may be provided on a distal end of the collection cylinders 16 for tracking the weight of material processed by the system 10. The weigh station 18 may tell the system 10 how much pressure, liquid nitrogen, and work is required to do a job or process materials. The weight station 18 may further read and save statistical data to assist in the developing of innovative research and a cleaner method of keeping the environment clean on a global and local scale. One or more safety sensors 68 may be disposed in the collection cylinders 16 to detect the presence of waste in the collection cylinders 16.

The waste may pass beyond the weigh station and into a liquid nitrogen chamber 22 (also referred to as a pressure chamber 22). Sound wave transducers 20 may be disposed about the liquid nitrogen chamber 22 for breaking down the flash frozen waste. A main liquid nitrogen input 24 and a re-pumped nitrogen input may provide liquid nitrogen into the liquid nitrogen chamber 22. A liquid nitrogen drain 30 may be provided on a lower end of the liquid nitrogen chamber 22 to recover the liquid nitrogen therefrom. A liquid nitrogen partition 28 may be used to contain the liquid nitrogen and one or more leak detectors 74 may be provided to detect a liquid nitrogen leak. A liquid nitrogen Dewar tank may be used, for example, to supply liquid nitrogen, as needed, to the main liquid nitrogen input 24.

While the Figures show a single pressure chamber 22, multiple pressure chambers 22 may be provided to freeze and further reduce the size of the material for a subsequent grinding and vacuum section.

The flash cooled and sound wave broken down waste may then pass to a grinding and vacuum section 36. Mechanical generators 32 may be provided to power the grinding and vacuum section 36. A top, counterclockwise rotating blade 46 may be disposed at one end of the grinding and vacuum section 36. A bottom, clockwise rotating blade 48 may be disposed at an opposite end of the grinding and vacuum section 36. Outside cylinders 40 and blade guides may rotate the blades 46, 48. A weight 44 may provide pressure on the blade 46. The weight 44 may drive the rotating blade 46 onto the waste 52 in the grinding and vacuum section 36. A vacuum system 50 may remove the ground waste from the grinding and vacuum section 36. A pressure valve 38 may be used to regulate the pressure within the grinding and vacuum section 36.

The ground waste may fall into the collection bags 56 disposed on one or more collection ramps 52. A user may remove the filled collection bags 56 via the collection bag access doors 58.

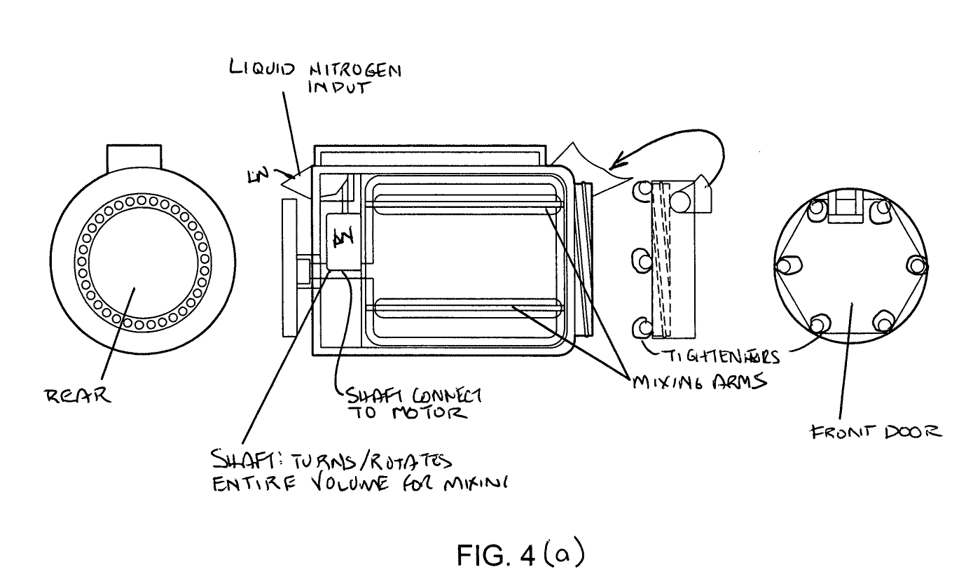

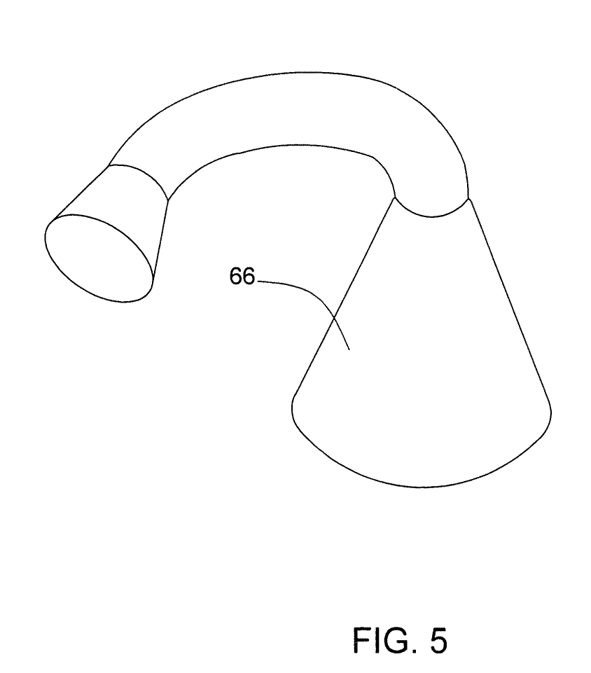

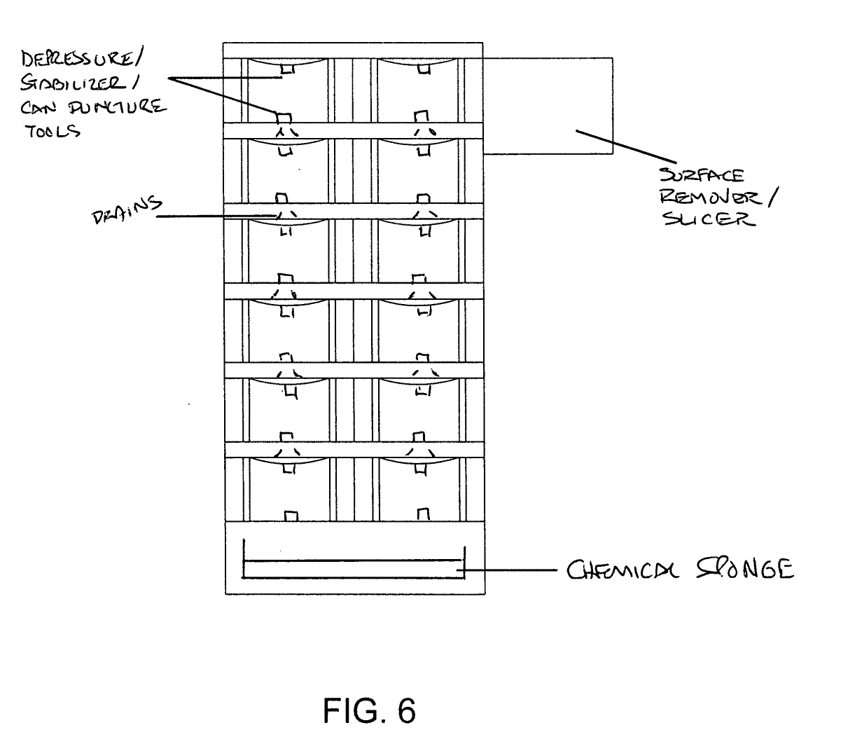

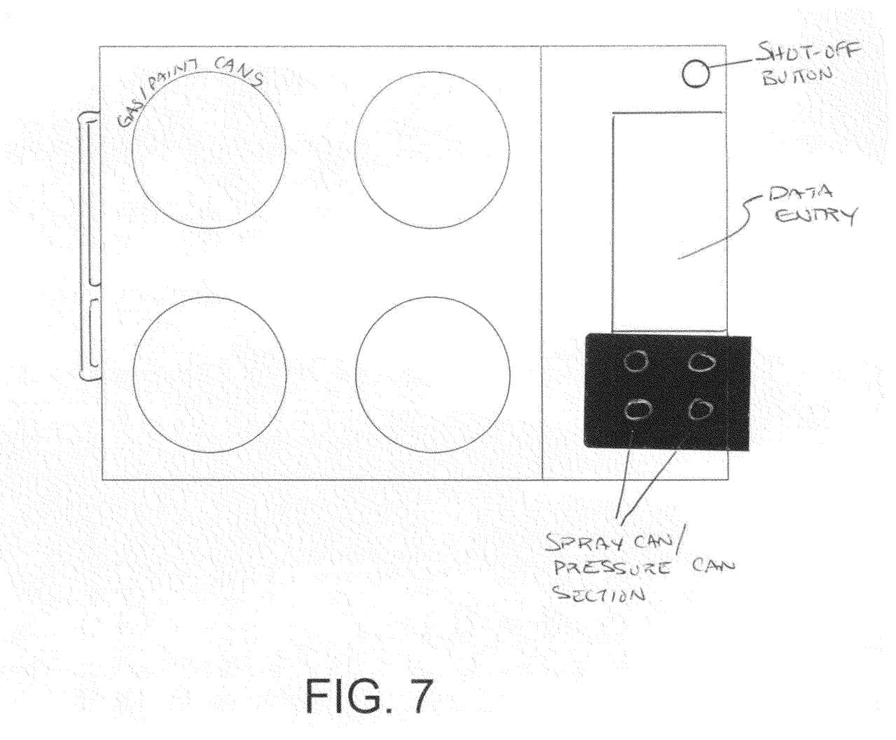

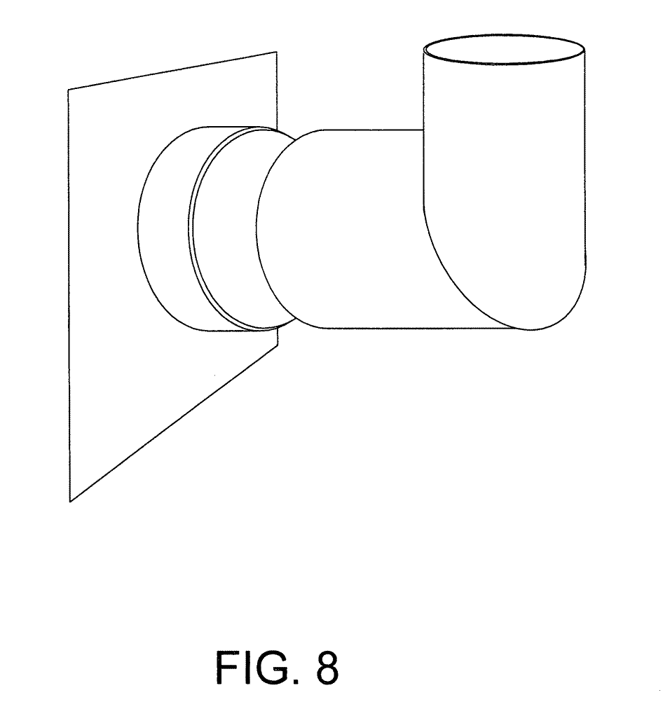

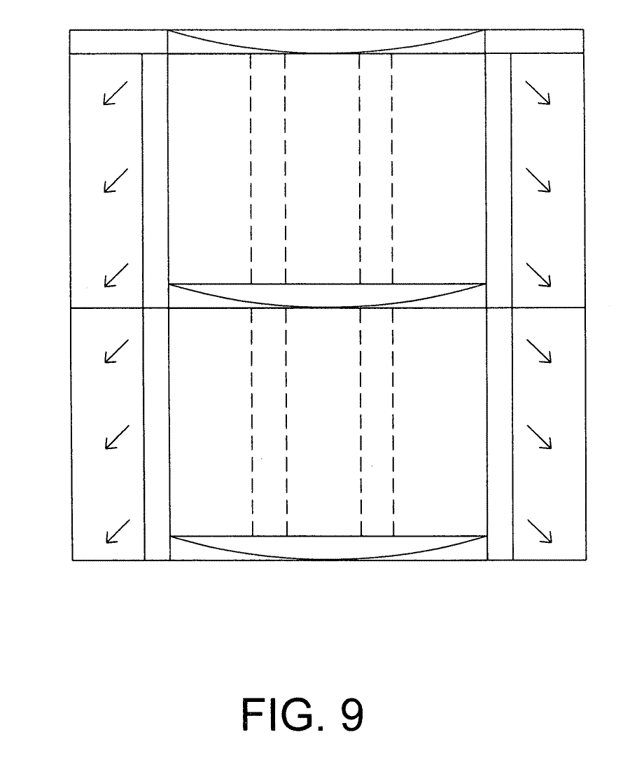

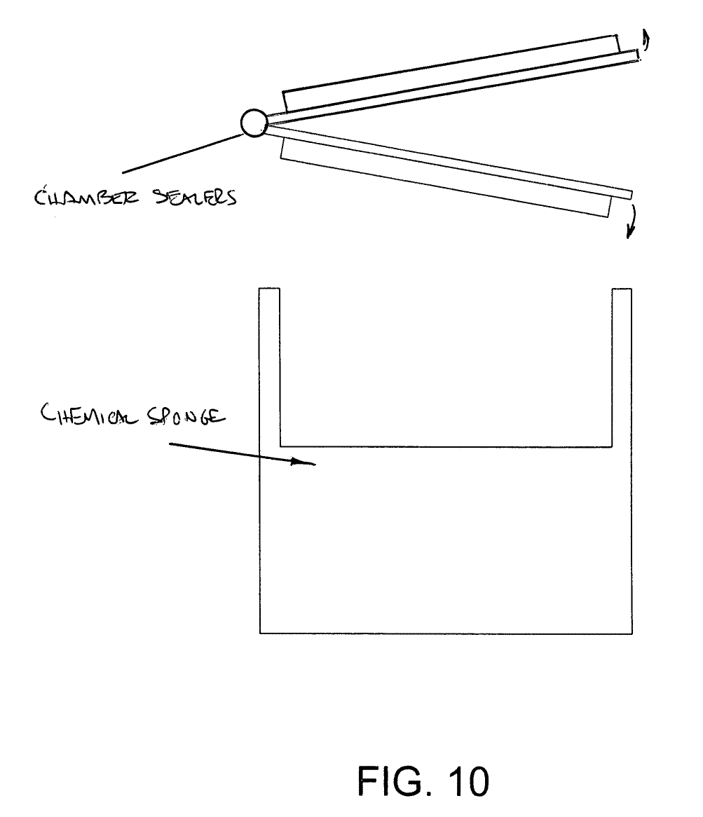

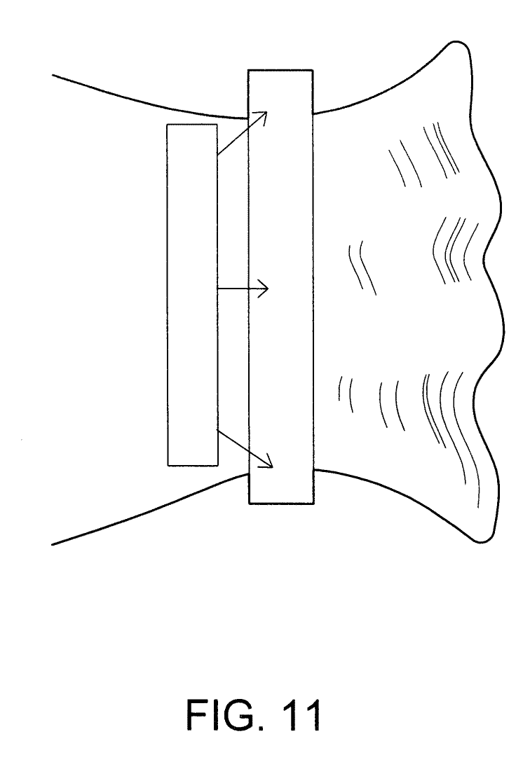

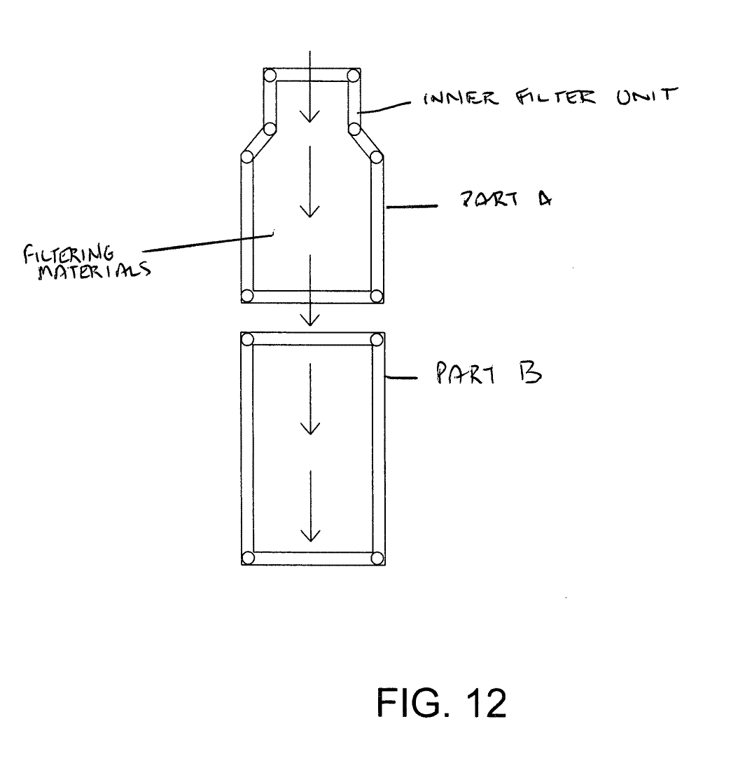

A spray and chisel attachment 60, as shown in FIG. 4, may have a liquid nitrogen hose 62 and a spring action/liquid nitrogen tip 64. This attachment 60 may be used to help flash freeze and break apart material to feed into the collection bowls 14. A vapor to solid attachment tool 66, as shown in FIG. 5, may also be optionally provided to the user.

To make the present invention, a strong pressure/sound-chamber with the ability to be continuously be sealed and opened at the request of completion, durable containment to hold and store waste in top cylinders may be built, a strong or durable grinding bit and vacuumed bags may be used. As described above, each component may be stacked by system's function to perform and seal with a frame and cover.

A pressure chamber may be added to the very start of containment and re-pressure. The added pressure chamber can be used to freeze and further reduce the size of material for grinding section of the device.

Instead of a consumer taking waste and directly placing it in a waste can that may be recycled; consumers pre-recycle by color-code to increase waste-management productivity and a possible opportunity to create a new goods and services that might stimulate an economy. Also, a consumer can take waste and use the present invention to regulate the waste storage at home, better serve any environment, and increase global trade of goods and services. As a statement, a personal could have a direct influence on the health of the planet and its populations.

Non-recyclable goods can find a new market place; for example, by combining materials to make new materials that could be stronger and lighter to be used globally. Aspects of the present invention may provide for the creation of a natural fertilizer to increase plant growth in disaster areas. Emissions can be reduced by making smaller units. Such units may be used with vehicles, for example. The output of the device may be used to make material for newer clothing, for example.

It should be understood, of course, that the foregoing relates to exemplary embodiments of the invention and that modifications may be made without departing from the spirit and scope of the invention as set forth in the following claims.

What is claimed is:

1. A pre-recycling system comprising:
one or more collection bowls adapted to collect material and pass the material to a weigh station;
a pressure chamber adapted to flash freeze the material and break down the material with sound waves;
a grinding and vacuum chamber adapted to grind material passing out of the pressure chamber; and
one or more collection bags adapted to collect waste dust exiting from the grinding and vacuum chamber.
